(19) United States
(12) Patent Application Publication
(10) Pub. No.: US 2016/0204430 A1
(43) Pub. Date: Jul. 14, 2016

(54) NONAQUEOUS ELECTROLYTE SECONDARY BATTERY

(71) Applicant: SANYO ELECTRIC CO., LTD., Daito-shi, Osaka (JP)

(72) Inventors: Tatsuki Hiraoka, Hyogo (JP); Kei Kobayashi, Osaka (JP); Masahiro Shiraga, Hyogo (JP)

(73) Assignee: SANYO Electric Co., Ltd., Daito-shi, Osaka (JP)

(21) Appl. No.: 14/910,868

(22) PCT Filed: Sep. 11, 2014
(86) PCT No.: PCT/JP2014/004690

§ 371 Date: Feb. 8, 2016

(30) Foreign Application Priority Data
Sep. 30, 2013 (JP) 2013-203348

(51) Int. Cl. H01M 4/48; H01M 4/131; H01M 4/525; H01M 4/587; H01M 4/36; H01M 10/0525; H01M 4/133

(52) U.S. Cl. CPC H01M 4/483; H01M 10/0525; H01M 4/131; H01M 4/133; H01M 4/587; H01M 4/364; H01M 4/525

(57) ABSTRACT

The generation of as in nonaqueous electrolyte secondary batteries during storage at elevated temperature is reduced to improve the elevated-temperature storage properties thereof. A nonaqueous electrolyte secondary battery includes a positive electrode, a negative electrode, and a nonaqueous electrolyte solution. The positive electrode contains an oxide containing lithium and a metal element M. The metal element N is at least one element selected from the group consisting of cobalt and nickel. The negative electrode contains SiOₓ (where x=0.5 to 1.5), a graphite having a BET specific surface area of 10 m²/g, and a material having a BET specific surface area of 10 m²/g, or more. The ratio a/M_{c} of the total content a of lithium in the positive and negative electrodes to the content M_{c} of the metal element M in the oxide is greater than 1.01.

### TECHNICAL FIELD

The present invention relates to nonaqueous electrolyte secondary batteries.

### BACKGROUND ART

Research has been directed toward the development of lithium-ion batteries with high energy density and high power through the use of metal materials capable of alloying with lithium, such as silicon, germanium, tin, and zinc, and oxides thereof as negative electrode active materials instead of carbonaceous materials such as graphite.

A negative electrode active material made of a metal material capable of alloying with lithium or an oxide thereof accepts lithium from a positive electrode active material during initial charge. However, not all lithium can be extracted during discharge; some lithium is trapped in the negative electrode active material, which results in an irreversible capacity. PTL 1 below discloses a nonaqueous electrolyte secondary battery in which SiOₓ used as a negative electrode active material and lithium is added thereto in advance in the amount equivalent to the irreversible capacity.

### CITATION LIST

### Patent Literature

PTL 1: Japanese Published Unexamined Patent Application No. 2007-242590

### SUMMARY OF INVENTION

### Technical Problem

Whereas the nonaqueous electrolyte secondary battery in PTL 1 exhibits improved initial charge-discharge efficiency and cycle characteristics, we have discovered that the battery generates an oxidizing gas during storage at elevated temperature.

### Solution to Problem

To solve the foregoing problem, a nonaqueous electrolyte secondary battery according to the present invention includes a positive electrode, a negative electrode, and a nonaqueous electrolyte solution. The positive electrode contains an oxide containing lithium and a metal element. M. The metal element N is at least one element selected from the group consisting of cobalt and nickel. The negative electrode contains SiOₓ (where x=0.5 to 1.5), a graphite having a BET specific surface area of less than 10 m²/g, and a material having a BET specific surface area of 10 m²/g or more. The ratio a/M_{c} of the total content a of lithium in the positive and negative electrodes to the content M_{c} of the metal element M in the oxide is greater than 1.01.

### ADVANTAGEOUS EFFECTS OF INVENTION

The nonaqueous electrolyte secondary battery according to the present invention generates less oxidizing gas during storage at elevated temperature and thus exhibits improved elevated-temperature storage properties.

### DESCRIPTION OF EMBODIMENTS

Embodiments of the present invention will now be described in detail.

A nonaqueous electrolyte secondary battery according to an example embodiment of the present invention includes a positive electrode containing a positive electrode active material, a negative electrode containing a negative electrode active material, a nonaqueous electrolyte containing a nonaqueous solvent, and a separator. An example nonaqueous electrolyte secondary battery is formed by winding the positive and negative electrodes with the separator therebetween to form an electrode assembly and placing the electrode assembly and the nonagueous electrolyte in a casing

### [Positive Electrode]

The positive electrode preferably includes electrode current collector and a positive electrode active material layer formed thereon. The positive electrode current collector is made of, for example, a conductive film, particularly a metal or alloy foil such as an aluminum foil or a film having a metal surface layer such as an aluminum layer, since such metals are stable within the potential range of the positive electrode. The positive electrode active material layer preferably contains a conductor and a binder in addition to the positive electrode active material.

The positive electrode active material contains an oxide containing lithium and a metal element M. The metal element M is at least one element selected from the group consisting of cobalt and nickel. Preferably, the positive electrode active material is a lithium transition metal oxide. The lithium transition metal oxide may contain non-transition metal elements such as Mg and Al. Examples of lithium transition metal oxides include lithium cobaltate and other lithium transition metal oxides such as those of Ni—Co—Mn, Ni—Mn—Al, and Ni—Co—Al. These lithium transition metal oxides may be used alone or in a mixture.

### [Negative Electrode]

The negative electrode preferably includes a negative electrode current collector and a negative electrode active material layer formed thereon. The negative electrode current collector is made of, for example, a conductive film, particularly a metal or alloy foil such as a copper foil or film having a metal surface layer such as a copper layer, since such metals are stable within the potential range of the negative electrode. The negative electrode active material layer preferably contains a binder in addition to the negative electrode active material. Although the binder may be, for example, polytetrafluoroethylene, the binder is preferably, for example, styrene-butadiene rubber (SBR) or polyimide. The binder may be used in combination with thickeners such as carboxymethylcellulose.

The negative electrode contains SiOₓ (where x=0.5 to 1.5), a graphite having a BET specific surface area of less than 10 m²/g, and a material having a BET specific surface area of 10 m²/g or more.

The SiOₓ particles are preferably at least partially covered with a conductive coating. The coating is a conductive layer made of a material having a higher conductivity than SiOₓ. The conductive, material forming the coating is preferably electrochemically stable. Preferably, the conductive material is at least one material selected from the group consisting of carbonaceous materials, metals, and metal compounds.

The SiOₓ particles at least partially covered with the conductive coating have a BET specific surface area of less than 10 m²/g, preferably 1 to 5 m²/g.

The mass ratio: of SiO₇ to graphite is preferably 1:99 to 50:50, more preferably 10:90 to 20:80. The use of SiOₓ in an amount of less than 1% of the total mass of the negative electrode active material would be of little advantage in achieving high capacity.

The graphite preferably has a BET specific surface area of more than 0.5 m²/g. If the graphite has a BET specific surface area of less than 0.5 m²/g, the negative electrode tends to have low Li-ion acceptability. More preferably, the graphite has a BET specific surface: area of 1 to 4 m²/g.

The material having a BET specific surface area of 10 m²/g or more preferably has a BET specific surface area of 300 m²/g or less. The material having a BET specific surface area of 10 m²/g or more also preferably has a BET specific surface area of 20 m²/g or more, more preferably 40 m²/g or more. A material having a BET specific surface area of less than 10 m²/g tends to be less effective in reducing the generation of an oxidizing gas during storage at elevated temperature. A material having a BET specific surface area of more than 300 m²/g tends to increase the irreversible capacity and thus decrease the energy density.

Examples of materials having BET specific surface areas of 10 m²/g or more include acetylene black, Ketjen Black, activated carbon, carbon nanofibers, and carbon nanotubes having BET specific surface areas of 10 m²/g or more.

The material having a BET specific surface area of 10 m²/g or more is preferably a conductive material.

The material having a BET specific surface area of 10 m²/g or more is preferably present in an amount of 5% to 50% by mass of SiOₓ. If the material having a BET specific surface: area of 10 m²/g or more is present in an amount of less than 5% by mass, it may be less effective in reducing the generation of an oxidizing gas. Nevertheless, the use of the material having a BET specific surface area of 10 m²/g or more in an amount of less than 5% by mass may be effective if it has large BET specific surface area. If the material having a BET specific surface area of 10 m²/g or more is present in an amount of more than 50% by mass, it tends to decrease the battery capacity.

### [Lithium Addition]

Lithium is added to the nonaqueous electrolyte secondary battery in advance in the amount equivalent to the irreversible capacity. Preferably, lithium is added to the negative electrode in advance in the amount equivalent to the irreversible capacity. Examples of methods for adding lithium to the negative electrode in advance in the amount equivalent to the irreversible capacity include the electrochemical charge of the negative electrode with lithium, the lamination of metallic lithium on the negative electrode, the deposition of lithium on the surface of the negative electrode, and the addition of a lithium compound to the negative electrode active material in advance. Lithium need not necessarily be added to the negative electrode in advance in the amount equivalent to the irreversible capacity; instead, it may be added to, for example, the separator or the positive electrode.

If the positive electrode active material contains an oxide containing lithium and a metal element M and the metal element M is at least one element selected from the group consisting of cobalt and nickel, the ratio a/M_{c} of the total content a of lithium in the positive and negative electrodes to the content M_{c} of the metal element M in the oxide is preferably greater than 1.01, more preferably greater than 1.03. If the ratio a/M_{c} falls within the above range, lithium ions are supplied in considerably large quantities in the battery. This is advantageous for compensating for the irreversible capacity.

The ratio a/M_{c} varies, for example, with the amount of metallic lithium foil laminated on the negative electrode. The ratio a/M_{c} can be calculated by determining the content a of lithium in the positive and negative electrodes and the content M_{c} of the metal element N in the positive electrode active material and dividing the content a by the content M_{c} of the metal element M.

The content a of lithium the content M_{c} of the metal element M can be determined as follows.

The battery is completely discharged and is disassembled. The nonaqueous electrolyte is removed from the battery, and the interior thereof is washed with a solvent such as dimethyl carbonate. Predetermined masses of samples are removed from the positive and negative electrodes and are analyzed by ICP spectroscopy to determine the content a (number of moles) of lithium in the positive and negative electrodes. The content M_{c} of the metal element M in the positive electrode is also determined by ICP spectroscopy in the same manner as the content of lithium in the positive electrode.

### [Nonaqueous Electrolyte]

Examples of electrolyte salts for the nonaqueous, electrolyte include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium salts of lower aliphatic carboxylic acids, LiCl, LiBr, LiI, chloroborane lithium, boric acid salts, and imide salts. Among these, LiPF₆ is preferred for its ionic conductivity and electrochemical stability. These electrolyte salts may be used alone or in combination. These electrolyte salts are preferably present in an amount of 0.8 to 1.5 mol per liter of the nonaqueous electrolyte.

Examples of solrents for the nonaqueous electrolyte include cyclic carbonates, linear carbonates, and cyclic carboxylates. Examples of cyclic carbonates include propylene carbonate (PC), ethylene carbonate (EC), and fluoroethylene carbonate (FEC). Examples of linear carbonates include diethyl carbonate (DEC), ethyl methyl carbonate (EMC), and dimethyl carbonate (DMC). Examples of cyclic carboxylates include γ-butyrolactone (GBL) and γ-valerolactone (GVL). Examples of linear carboxylates include methyl propionate (MP) and fluoromethyl propionate (FMP). These nonaqueous solvents may be used alone or in combination.

### [Separator]

The separator is a porous sheet with ion permeability and insulation properties. Examples of porous sheets include microporous films, woven fabrics, and nonwoven fabrics. Preferred separator materials include polyolefins such as polyethylene and polypropylene.

### EXAMPLES

The present invention is further illustrated by the following examples, although these examples are not intended to limit the invention.

### Example 1

### <Experiment 1>

### (Fabrication of Positive Electrode)

Lithium cobaltate, acetylene black (HS100, Denka Company Limited), and polyvinylidene fluoride (PVdF) were weighed and mixed in a mass ratio of 95.0:2.5:2.5, and N-methyl-2-pyrrolidone (NMP) was added as a dispersion medium. The mixture was stirred with a mixer (T.K. HIVIS MIX, Primix Corporation) to obtain a positive electrode slurry. The positive electrode slurry was applied to each side of a positive electrode current collector made of aluminum foil. After drying, the positive electrode current collector was rolled with a roller to obtain a positive electrode including a positive electrode mixture layer formed on each side of the positive electrode current collector. The positive electrode mixture layer had a density of 3.60 g/mL.

### (Fabrication of Negative Electrode)

A mixture of carbon-coated SiOₓ (where x=0.93, average primary particle size: 6.0 μm) and graphite (average primary particle size: 10 μm, BET specific surface area: 2.5 m²/g) in a mass ratio of 10:90 was used as a negative electrode active material. The negative electrode active material, artificial graphite powder (SP5030, Nippon Graphite Industries, Co., Ltd.) (average primary particle size: 5 μm, BET specific surface area: 65 m²/g), carboxymethylcellulose (CMC), serving as a thickener, and styrene-butadiene rubber (SBR), serving as a binder, were mixed in a mass ratio of 93:5:1:1, and water was added as a diluent. The mixture was stirred with a mixer (T.K. HIVIS MIX, Primix Corporation) to obtain a negative electrode slurry. The negative electrode slurry was uniformly applied to each side of a negative electrode current collector made of copper foil in an amount of 190 g per square meter of the negative electrode mixture layer. After drying in air at 105° C., the negative electrode current collector was rolled with a roller to obtain a negative electrode including a negative electrode mixture layer formed on each side of the negative electrode current collector. The negative electrode mixture layer had a density of 1.60 g/mL.

### [Lithium Addition]

Lithium was added to the resulting negative electrode by laminating a lithium foil having a thickness of 5 μm, which is equivalent to the irreversible capacity.

### [Preparation of Nonaqueous Electrolyte Solution]

A nonaqueous electrolyte solution was prepared by adding lithium hexafluorophosphate (LiPF₆) to a mixture of ethylene carbonate (EC) and diethyl carbonate (DEC) in a volume ratio of 3:7 to a concentration of 1.0 mol/L.

### [Assembly of Battery]

Tabs were attached to the electrodes. The positive and negative electrodes were spirally wound with the separator therebetween such that the tabs were located on the outermost periphery to obtain a wound electrode assembly. The electrode assembly was inserted into a casing made of an aluminum laminated sheet. After drying in a vacuum at 105° C. for 2 hours, the nonaqueous electrolyte solution was injected into the casing, and the opening thereof was sealed to obtain Battery A1. Battery A1 had a design capacity of 800 mAh.

### <Experiment 2>

Battery A2 was fabricated in the same manner as Battery A1 except that no lithium was added in the fabrication of the negative electrode.

### <Experiment 3>

Battery A3 was fabricated in the same manner as Battery A1 except that, in the fabrication of the negative electrode, the negative electrode active material, CMG, and SBR were mixed in a mass ratio of 98:1:1, and no lithium was added.

### <Experiment 4>

Battery B1 was fabricated in the same manner as Battery A1 except that, in the fabrication of the negative electrode, graphite (average primary particle size: 10 μm, BET specific surface area: 2.5 m²/g) was used alone as a negative electrode active material without using SiOₓ, and no lithium was added.

### <Experiment 5>

Battery B2 was fabricated in the same manner as Battery A1 except that, in the fabrication of the negative electrode, graphite (average primary particle size: 10 μm, BET specific surface area: 2.5 m²/g) was used alone as a negative electrode active material without using SiOₓ, the negative electrode active material, CMC, and SBR were mixed in a mass ratio of 98:1:1, and no lithium was added.

### (Experiment)

Batteries A1 to A3 and B1 and B2 were tested for the initial charge-discharge efficiency given by formula (1) below by charging and discharging the batteries under the following conditions. The results are summarized in Table 1.

### [Charge-Discharge Conditions]

Each battery was charged at a constant current of 1.0 it (800 mA) to a battery voltage of 4.2 V and was then charged at a constant voltage of 4.2 V to a current of 0.05 it (40 mA). After the battery was left standing for 10 minutes, the battery was discharged at a constant current of 1.0 it (800 mA) to a battery voltage of 2.75 V.

### [Formula for Calculating Initial Charge-Discharge Efficiency]

Initial charge-discharge efficiency (%)=(discharge capacity at first cycle/charge capacity at first cycle)×100 (1)

After the initial charge and discharge, the battery was charged at a constant current of 1.0 it (800 mA) to a battery voltage of 4.2 V, was charged at a constant voltage of 4.2 V to a current of 0.05 it (40 mA), and was stored at 80° C. for 2 days.

After storage, the battery was examined for the amount of gas generated. The results are summarized in Table 1. The amount of gas generated was measured by the buoyancy method. Specifically, the amount of gas generated during storage was determined from the difference between the mass of the battery after storage in water and the mass of the battery before storage in water. The major constituent of the resulting gas was an oxidizing gas.

TABLE 1

| | Negative electrode | | | | Initial | Amount |
|---|---|---|---|---|---|---|
| | active material | | | | charge- | of gas |
| | Graphite | SiOₓ | | Lithium | discharge | gener- |
| Bat- | (% by | (% by | | Addi- | efficiency | ated |
| tery | mass) | mass) | SP5030 | tion | (%) | (cc) |
| A1 | 90 | 10 | Added | Added | 92 | 0.16 |
| A2 | 90 | 10 | Added | Not added | 83 | 0.15 |
| A3 | 90 | 10 | Not added | Not added | 81 | 2.58 |
| B1 | 100 | — | Added | Not added | 90 | 0.16 |
| B2 | 100 | — | Not added | Not added | 90 | 0.21 |

As can be seen from Table 1, the results for Batteries A1 to A3, which contained a graphite having a BET specific surface area of less than 10 m²/g and SiOₓ as negative electrode active materials, show that the amounts of gas generated in Batteries A1 and A2, which contained a material having a BET specific surface area of 10 m²/g or more, after storage at elevate temperature decreased significantly, i.e., to about one-seventeenth of the amount of gas generated in Battery A2. The results for Batteries B1 and B2, which contained graphite alone as a negative electrode active material, show that the use of a material having a BET specific surface area of 10 m²/g or more slightly decreased the amount of gas generated after storage at elevate temperature. However, these batteries containing graphite alone as a negative electrode active material intrinsically did not pose the problem of gas generation during storage at elevate temperature.

Although a negative electrode active material containing graphite and SiOₓ a mass ratio of 10:90 was used in the above example experiments, the use of a material having a BET specific surface area of 10 m²/g or more will be more effective in reducing the amount of gas generated as the ratio of the mass of SiOₓ to the total mass of the negative electrode active material is increased.

### <Reference Experiments>

The following reference experiments were conducted to examine the ratio a/M_{c} of batteries to which lithium was added before charge and discharge.

### <Reference Experiment 1>

Carbon-coated SiOₓ (where x=0.93, average primary particle size: 5.0 μm) was provided, and 1 mol of the SiOₓ and 0.2 mol of LiOH were mixed together in powder form (the proportion of LiOH to the SiOₓ was 20 mol %) to deposit LiOH on the surface of the SiOₓ. The mixture was then heat-treated in an Ar atmosphere at 800° C. for 10 hours to obtain SiOₓ having lithium silicate phases formed therein. The heat-treated SiOₓ was analyzed by XRD (Cu—Kα radiation). The analysis showed peaks for lithium silicates, i.e., Li₄SiO₄ and Li₂SiO₂.

Battery E1 was fabricated as in Example Experiment 2 except that a mixture of graphite and the SiOₓ having lithium silicate phases formed therein was used as a negative electrode active material, and the heat-treated SiOₓ was mixed in an amount of 5% of the total mass of the negative electrode active material.

### <Reference Experiment 2>

Battery E2 was fabricated as in Reference Experiment 1 except that the heat-treated SiOₓ was mixed in an amount of 10% of the total mass of the negative electrode active material in the fabrication of the negative electrode.

### <Reference Experiments 3 and 4>

Batteries Y1 and Y2 were fabricated as in Reference Experiments 1 and 2, respectively, except that SiOₓ having no lithium silicate phase formed therein was used as a negative electrode active material in the fabrication of the negative electrode.

### (Experiment)

Batteries E1, E2, Y1, and Y2 were tested for the initial charge-discharge efficiency given by equation (1) above by charging and discharging the batteries under the following conditions. The results are summarized in Table 2.

### [Charge-Discharge Conditions]

Each battery was charged at a constant current of 1.0 it (800 mA) to a battery voltage of 4.2 V and was then charged at a constant voltage of 4.2 V to a current of 0.05 it (40 mA). After the battery was left standing for 10 minutes, the battery was discharged at a constant current of 1.0 it (800 mA) to a battery voltage of 2.75 V.

[Ratio a/M_{c} of Content a of Lithium in Positive and Negative Electrodes to Content M_{c} of Metal Element M in Positive Electrode Active Material]

These batteries were examined for the content a of lithium in the positive and negative electrodes and the content M_{c} of the metal element M in the positive electrode material as described above, and the ratio a/M_{c} was calculated. The results are summarized in Table 2.

TABLE 2

| | | SiOₓ content | Initial |
|---|---|---|---|
| Battery | Ratio x/Mc | (% by mass) | charge-discharge efficiency (%) |
| E1 | 1.03 | 5 | 90 |
| Y1 | 1.01 | | 87 |
| E2 | 1.05 | 10 | 88 |
| Y2 | 1.01 | | 84 |

1. A nonaqueous electrolyte secondary battery comprising a positive electrode, a negative electrode, and a nonaqueous electrolyte solution, wherein
the positive electrode comprises an oxide containing lithium and a metal element M, the metal element M being at least one element selected from the group consisting of cobalt and nickel,
the negative electrode comprises SiOₓ (wherein x=0.5 to 1.5), a graphite having a BET specific surface area of less than 10 m²/g, and a material having a BET specific surface area of 10 m²/g or more, and
the ratio a/M_{c} of the total content a of lithium in the positive and negative electrodes to the content M_{c} of the metal element M in the oxide is greater than 1.01.

2. The nonaqueous electrolyte secondary battery according to claim 1, wherein the material having a BET specific surface area of 10 m²/g or more has a BET specific surface area of 10 to 300 m²/g.

3. The nonaqueous electrolyte secondary battery according to claim 1, wherein the material having a BET specific surface area of 10 m²/g or more is a conductive material.
